(19) United States
(12) Patent Application Publication
(10) Pub. No.: US 2025/0131361 A1
(43) Pub. Date: Apr. 24, 2025

(54) SYSTEM AND METHOD FOR DATA EXTRACTION, EVALUATION AND ASSESSMENT

(71) Applicant: ROYAL BANK OF CANADA, Toronto (CA)

(72) Inventors: Salah SHARIEH, Toronto (CA); Evgenii OSTANIN, Toronto (CA); Brett NOYE, Toronto (CA); Paula DUZI, Toronto (CA); Fatima HUSSAIN, Toronto (CA); Andrea RICCI, Toronto (CA); Nebojsa DJOSIC, Toronto (CA)

(21) Appl. No.: 18/920,876

(22) Filed: Oct. 19, 2024

Related U.S. Application Data
(60) Provisional application No. 63/655,183, filed on Jun. 3, 2024.
(60) Provisional application No. 63/591,549, filed on Oct. 19, 2023.
(60) Provisional application No. 63/591,560, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.

(51) Int. Cl. G06Q 10/0635; G06V 30/414

(52) U.S. Cl. CPC G06Q 10/0635; G06V 30/414

(57) ABSTRACT

There is provided an automated system for extracting data from a set of documents corresponding to a vendor, contractor, or product. Documents may be converted to text-based documents and text may be extracted therefrom based on keywords and phrases. Extracted sentences may be mapped to requirements for an assessment. The documents may be processed in batches to determine whether the extracted text is sufficient to perform the assessment. The assessment may be performed and output a score indicating the degree to which the vendor, contractor or product complies with requirements. Processing of documents, as well as processing of evaluations, and processing of multiple assessments, may be performed in parallel.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655, 183, filed Jun. 3, 2024, the entire contents of each of the above-identified applications being incorporated herein by reference.

### FIELD

This relates generally to computerized systems used for data extraction, evaluation and assessment.

### BACKGROUND

The use of computerized systems and software has become ubiquitous throughout organizations. In many organizations, the use of third party Software-as-a-Service (SaaS) applications (i.e. SaaS applications which are created and administered outside of the organization using the SaaS) is becoming increasingly common, as modern communications systems have overcome bandwidth limitations which might have limited the utility of such SaaS applications and vendor and contractor services in the past. Moreover, an increasing number of vendors have shifted to only offering SaaS and remote distribution models.

However, there are a number of challenges inherent with the use of third party vendors, contractors, and SaaS applications for organizations. For example, most organizations may be subject to regulations and/or compliance requirements to which the organizations are required to adhere. When computer and/or software systems are developed and implemented within an organization, services provided by internal employees (e.g., systems and/or procedures), practices and policies may be tailored to the particular regulations and/or compliance requirements to which the organization is bound, thus leaving the organizations in full control. However, third party vendors, contractors and SaaS applications may not have been developed with a particular set of regulations or compliance requirements in mind, particularly given that compliance requirements might vary from customer to customer, and as such there might not be a uniform set of standards for to which a particular SaaS application must adhere. Moreover, the delivery system may keep operations, policies, and procedures outside of the organization's control.

For many organizations, adherence to regulatory and compliance requirements is of paramount importance, and ensuring that any proposed new vendor, contractor, SaaS product is compliant with regulations and/or compliance requirements may be a time-consuming and onerous task, which may prevent, impede, or retard the adoption of improved technologies and services. Moreover, ensuring that an existing vendor, contractor, or SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

The initial compliance assessment (e.g., before contracts are signed or purchases are made) is typically and mostly based on product documentation provided by the third-party vendors. Often, this documentation is highly technical and extensive in nature (e.g., sizable, substantial, immense). Due to the specific compliance requirements (e.g., guidelines, policies and standards) and regulations for a particular organization, each organization may have to conduct its own preliminary compliance assessments, prior to purchase, and the initial on-boarding compliance assessment at the time the consumption of services and products begins. Similar assessments may be required on regular intervals, or at the time of a significant change to consumed services and products.

Accordingly, there is a need for a computing system which facilitates document processing and information extraction for the purposes of, for example, regulatory compliance. It would be beneficial to further ensure that third party vendors, contractors and SaaS applications are operating as intended, and continue to operate as intended and in compliance with regulations and compliance requirements specific to the specific organization. It would be of further benefit to provide ongoing regulatory compliance as services and products change, regulations change, and consumed products and services continue to change at an increasing pace.

### SUMMARY

According to an aspect, there is provided a method comprising: receiving a plurality of documents; defining a batch comprising a subset of said plurality of documents; extracting, from each document of said batch, unstructured text; extracting, from said extracted unstructured text, a plurality of text segments; labelling and/or mapping one or more of said plurality of text segments to one or more requirements from a set of requirements configured for an assessment; evaluating whether said labelled and/or mapped text segments satisfy a minimum requirement threshold associated with said set of requirements for said assessment; and when said minimum requirement threshold is satisfied, determine assessment scores for each requirement in said set of requirements for said assessment.

According to another aspect, there is provided a system comprising: a processor; and a computer-readable storage medium having stored thereon computer-executable instructions that, when executed by said processor, cause the processor to perform a method comprising: receiving a plurality of documents; defining a batch comprising a subset of said plurality of documents; extracting, from each document of said batch, unstructured text; extracting, from said extracted unstructured text, a plurality of text segments; labelling and/or mapping one or more of said plurality of text segments to one or more requirements from a set of requirements configured for an assessment; evaluating whether said labelled and/or mapped text segments satisfy a minimum requirement threshold associated with said set of requirements for said assessment; and when said minimum requirement threshold is satisfied, determine assessment scores for each requirement in said set of requirements for said assessment.

According to still another aspect, there is provided a computer-readable storage medium having stored thereon computer-executable instructions that, when executed by said processor, cause the processor to perform a method comprising: receiving a plurality of documents; defining a batch comprising a subset of said plurality of documents; extracting, from each document of said batch, unstructured text; extracting, from said extracted unstructured text, a plurality of text segments; labelling and/or mapping one or more of said plurality of text segments to one or more requirements from a set of requirements configured for an assessment; evaluating whether said labelled and/or mapped text segments satisfy a minimum requirement threshold associated with said set of requirements for said assessment; and when said minimum requirement threshold is satisfied, determine assessment scores for each requirement in said set of requirements for said assessment.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at computing device;

FIG. 4 depicts a simplified arrangement of a data extraction and analysis process;

FIG. 5 depicts an example data extraction, entity matching and labelling process;

FIG. 6 depicts an example data extraction process;

FIG. 7 depicts an example evaluation process;

FIG. 8 depicts an example assessment process; and

FIG. 9 depicts an example ensemble assessment process.

### DETAILED DESCRIPTION

It should be appreciated that although this disclosure contains numerous examples relating to the extraction of data from SaaS application and vendor documents, the systems and methods described herein may have applications for extracting data from documents in a wide variety of different domains, including but not limited to educational documents, legal documents, medical documents, and the like. It should be appreciated that some embodiments may be capable of being applied in any domain in which domain experts can provide accurate, detailed definitions of what they are looking for, have a set of documents available as a search space, and can assign a relative importance of a searched-for configuration for evaluation and/or assessment. It will be appreciated that the example embodiments described below are merely examples which serve to illuminate aspects of some embodiments of the invention, but these examples are not intended to be limiting.

In some embodiments, an automated computing system may process unstructured textual documents, including but not limited to PDF and HTML formatted documents. Often, such document formats are not in any specific format or standard layout. Moreover, such documents may contain a wide variety of information scattered around in free-form text, sometimes across multiple documents. To extract specific information from such document formats, the system may be required to extract parts of text, sentences and phrases. In some embodiments, this may be accomplished by looking for specific key words and phrases (e.g., ISO 27001, SOC1, SOC2, security report, audit report, and the like). Keywords and phases may change over time, and may depend on internal documents, governance policies, and practices specific to a particular organization. Once extracted from these documents, the information may be evaluated for completeness and mapped to organization-specific requirements. In some embodiments, organization-specific requirements may be expressed as questions developed from internal policies (e.g., “what security reports are provided?”, “at what frequency are security reports provided?”, and the like).

Common attempts at extracting the above-noted information from documents may include the use of Generative Artificial Intelligent (AI) techniques, such as Large Language Models (LLM). However, generative AI techniques may not be suitable for these purposes for a number of reasons. For example, LLMs may require a significant amount of time and money to train, update and operate. As such, only a few large organizations have developed and operate sufficiently powerful LLMs, and for a sizable fee. The cost of extracting information from specific, recently published documents would first require uploading the document and then extracting information from the uploaded document using prompt-engineering techniques. The cost of the aforementioned process would quickly exceed the benefit derived therefrom, and would additionally be a time-consuming effort. Moreover, attempting automation using third-party LLM products would depend heavily on the third party LLM, whose development, operations, costs, features, and pace of change would be outside of the control of the organization.

In some embodiments, there is provided a computer-based method and system for extracting specific information from a set of documents, and to organize and evaluate the completeness of extracted information, and map extracted information to a pre-determined set of requirements and provide an assessment in accordance with requirement configurations. Such systems and methods may be highly flexible, dynamic, interactive, and configurable. Some embodiments described herein may be more efficient, as they may be capable of running on standard CPUs in standard-size containers in regular hyperscaler environments (e.g., AWS, Azure, and Google Cloud). Moreover, in some embodiments, the effort to develop, improve and/or operate such systems would remain within the control of the organization rather than a third party. Thus, some embodiments described herein may be specifically designed to at least one of respect internal organizational structures and facilitate division of responsibilities, internal organizational structure, policies and practices, separation of concerns, and accountability and reporting hierarchies. Some embodiments described herein may be developed and executed internally within an organization, thus alleviating reliance on externally developed LLMs and other resources.

At present, a given organization may use hundreds of third-party vendor and/or contractor provided services and software products, including Software-as-a-Service (SaaS) applications. Each vendor and each product may go through risk and other compliance assessment processes, which are typically specific to each individual organization and are normally outlined in a set of policy, procedures, and requirement documents. Such policy, procedure and requirement documents typically evolve over time, particular as laws and regulations governing an organization change. To perform risk assessments, an organization will typically create a number of requirement and/or questionnaire documents for different types of vendors, contractors, and SaaS applications and products.

Likewise, vendors and contractors typically create a set of documents which will be used across different organizations, which evolve as vendors, contractors and SaaS applications change their services and products (for example, when a new feature is added to a product), and/or add more requested compliance reports, standards, and practices. These vendor and contractor documents are typically in the form of free-form text documents, without any standard structure or layout. As such, during the assessment process, information is extracted from these documents as they exist at that point in time, based on the current organization-specific requirements and/or questionnaire documents.

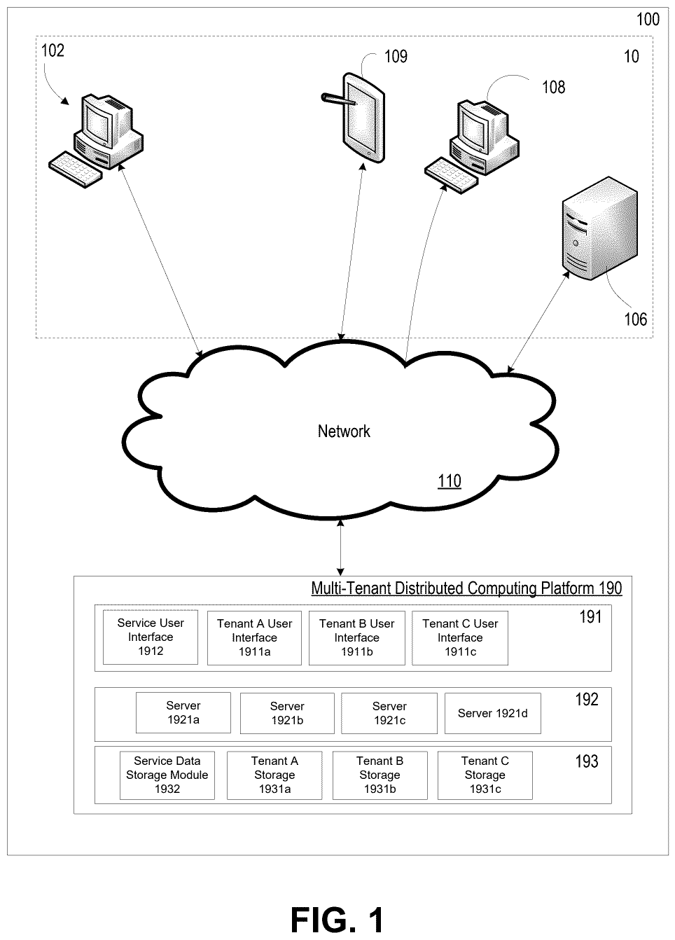

Various embodiments of the present invention may make use of interconnected computer networks and components. FIG. 1 is a block diagram depicting components of an example computing system 100. Components of the computing system are interconnected to define a compliance and risk assessment system. As used herein, the term “compliance and risk assessment system” refers to a combination of hardware devices configured under control of software and interconnections between such devices and software.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 118 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1. In some embodiments, one or more computing devices may be logically internal to an organization 10 (depicted in FIG. 1 as devices 102, 109, 108 and 106 being internal to organization 10).

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g., service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g., Amazon, Microsoft, Google, or the like) in order to provide multiple tenants with applications, data storage, and functionality. A multi-tenant system as depicted in FIG. 1 may include multiple different applications (e.g., multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

In some embodiments, systems such as extraction and evaluation system 126 may be executed locally within organization 10, without requiring the extensive computing resources of distributed computing platform 190. This may be advantageous in that an organization may have full control over the design and architecture of extraction and evaluation system 126, as described herein.

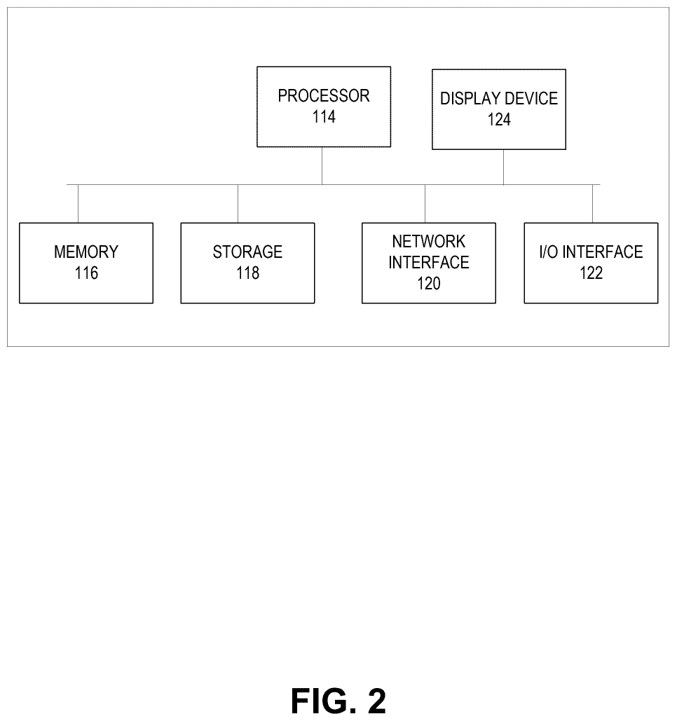

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third-party SaaS applications (e.g., SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

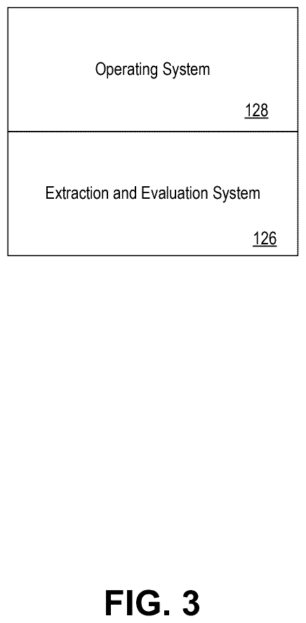

FIG. 3 depicts a simplified arrangement of software at an example computing device. The software may include an operating system 128 and application software, such as extraction and evaluation system 126. It will be appreciated that in distributed computing environments, implementation, and administration of an application such as system 126 may be distributed amongst a plurality of separate computing devices within organization 10, and FIG. 3 is intended to depict a simplified logical separation between an operating system 128 and an application executing thereon on an example computing device(s). In some embodiments, extraction and evaluation system 126 may function in co-operation with a compliance and risk assessment system which may be provide various inputs, including but not limited to configurations for assessments based on rules extracted from various rule sources. Various example components of an example compliance and risk system are described in U.S. Provisional Patent Application Nos. 63/591,549, 63/591,560, 63/591,566, 63/591,646, and 63/591,690, filed Oct. 19, 2023, the entire contents of each of which are incorporated herein by reference.

Some embodiments described herein may represent enhancements over such systems. For example, some embodiments described herein may allow an organization to develop, improve and/or operate a compliance system internally within organization 10, without reliance on tools such as third party LLM solutions, thereby ensuring greater control over respecting the organization's 10 internal organizational structures. For example, a Large Language Model (LLM) which is on a significantly lower scale than mainstream LLMs (such as ChatGPT) may be stored locally within an organization 10 (for example, the size of such an LLM model might be 500 megabytes to a few gigabytes). As such, this locally stored LLM may be run locally without reliance on cloud or distributed computing systems 190. For example, an LLM may be executed locally on an OpenShift platform.

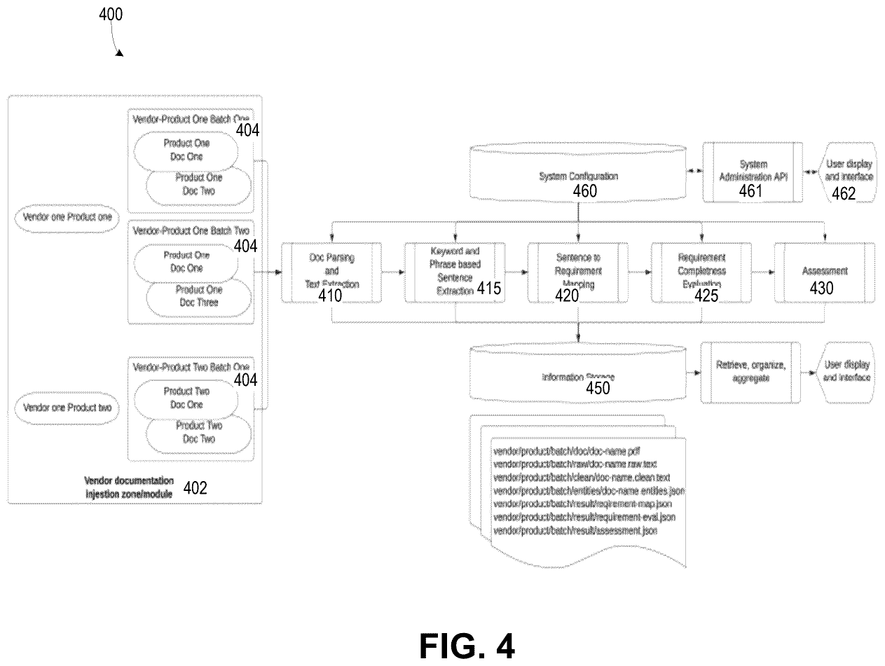

FIG. 4 is a diagram depicting a simplified arrangement of high-level logical system components of a system that performs data extraction and analysis processes 400 which may be used as part of a compliance and risk assessment system, in accordance with some embodiments.

As depicted in FIG. 4, an example process 400 of risk and compliance assessment may begin with collecting or receiving documentation 402. The collected documents may be processed through parsing and text extraction block 410. In some embodiments, the output of block 410 may be stored in information store 450. As depicted, the output of block 410 is provided as an input to keyword and phrase-based sentence extraction block 415. As depicted, the output of block 415 may be provided to mapping block 420. In some embodiments, the output of block 420 may be stored in information store 450. As depicted, the output of block 420 may be provided to requirement completeness evaluation block 425. Finally, as depicted, the output of block 425 may be provided to assessment block 430 when certain conditions are satisfied, as described herein. In some embodiments, the output of block 430 may be stored in information store 450.

In some embodiments, documentation 402 may include vendor, contractor, and/or SaaS application documents which are available. As depicted in FIG. 4, some documents 402 may relate to a particular vendor, a particular product made by a particular vendor, and may relate to a plurality of different vendors and a plurality of different products. In some embodiments, a subset of documents 402 (as they exist at a particular point in time) may be selected for inclusion in a batch 404. In some embodiments, a universally unique ID (e.g., UUID version 4) and a composite unique key may be generated for each document 402 and/or each batch 404. In some embodiments, the composite unique key may include a vendor unique acronym (e.g., a stock market symbol, or the like), a product or service key unique to the vendor's domain, a batch checksum value, and a date and time of batch processing.

In some embodiments, the batch checksum for batch 404 may be calculated by concatenating checksums of each individual document 402 in batch 404 and generating a checksum of the concatenated checksum string. In so doing, when the same batch 404 of documents has been processed more than one time, each batch will have a unique key (as a result of the date and time of batch processing in the composite unique key) and a UUID. This may be useful for keeping track of different versions of batches 404.

For example, it is common for new documents (or updated versions of documents) to trickle in over time from vendors. When a document 402 within batch 404 changes, the batch 404 will be re-processed and the newly processed batch will have a new unique composite key. This may facilitate the distinguishing between unchanged, previously processed documents and change and/or new documents. This may be useful in facilitating the ‘skipping’ of processing unchanged documents during certain operations where appropriate (e.g., sentence extraction, as described below). Moreover, the use of checksums and UUIDs for each batch 404 may facilitate repeating the processing of batches without any pre-processing or penalty, which may make automation more efficient. For example, when a small number of additional documents is received for an assessment and the remaining set of documents is otherwise unchanged, the new documents may be added to the previously processed batch and the updated batch may be processed again.

Once batch 404 has been created, process 400 may continue to an optional text extraction block 410. In some embodiments, text extraction may be necessary when the format of one or more of documents 402 does not include text data. For example, a PDF document may be provided as images of text, rather than text data. Text data may be extracted from such documents 402 in various ways to obtain a raw, plain text document. In some embodiments, the extracted raw, plain text document may be saved to storage 450. In some embodiments, the extracted plain text document may be assigned a unique checksum value, which may allow the extracted document to be processed multiple times (for example, the same document may be processed in different ways as part of different types of assessments). Advantageously, a unique checksum value for the raw text extracted component may further allow for efficient confirmation of whether the document has changed or not. Additionally, the storing of the extracted raw, plain text document to storage 450 may allow for copies of the plain text document to be made and processed in parallel (thereby allowing multiple different assessments to be conducted using the same underlying document in parallel, which enhances efficiency of the overall process).

In some embodiments, one or more documents 402 of batch 404 may be processed to perform text cleanup operations as part of compliance assessment process 400. In some embodiments, text cleanup may include a configurable set of text cleanup operations, with the clean-text output saved to storage 450. Text clean up operations may include, but are not limited to, removal of non-text/printable characters, empty lines, extraneous spaces, and the like. As such, a configuration for text cleanup may include a selection of text cleanup operations to perform. In some embodiments, if a change is made to the text cleanup configuration, individual documents 402 or whole batches 404 of documents may be re-processed in accordance with the updated configuration. In some embodiments, such re-processing may be performed in real-time. In some embodiments, the text cleanup operations may be performed in parallel on individual documents 402 within batch 404. In some embodiments, data may be kept in separate records corresponding to each separate document 402 from which data was extracted.

In some embodiments, at block 415, parts of text may be extracted from each document 402 in batch 404. In some embodiments, the particular parts of text may include sentences and/or phrases. In some embodiments, the output of extracted sentences and/or phases may be stored in a separate record for each respective document 402 in batch 404 and stored in storage 450. In some embodiments, individual documents 402 from batch 404 may be processed in parallel at block 415.

In some embodiments, the extraction of parts of text may be based on a system configuration 460. In some embodiments, the system configuration can be modified by a user (e.g., via user interface and display and system administration API), whether in real-time or at other predetermined intervals.

In some embodiments, configuration 460 may specify one or more sets of keywords and phrases. In some embodiments, each set of keywords and phrases may require a separate processing cycle for each document 402 in batch 404 (although it will be appreciated that each cycle may be performed in parallel, thus significantly reducing the amount of time required to perform block 415). It is expected that multiple assessments may be required when each assessment is based on a different set of requirements and/or questionnaires (which are based on different policy and procedure documents). For example, a vendor risk assessment and a vendor security assessment will typically be distinct assessments defined by different teams within an organization, although the same set of vendor documents 402 is likely to be used for both assessments. As such, for each set of keywords and phrases in configuration 460, block 415 may be configured to enumerate sentences in the clean text of each document 402 in batch 404, find keywords and phases, extract relevant sentences, and assign a label associated with keywords and create a document (e.g., in JSON format or the like) and store the document in storage 450.

In some embodiments, storage 450 may include a traceable set of records for each document 402 in a batch 404 for each assessment run. In some embodiments, each record may include one or more of the original document 402, raw text corresponding to document 402, clean text corresponding to document 402, and extracted text from document 402. In some embodiments, the extracted text set may be an empty set with zero size (e.g., if no matches for keywords and phrases are found for a particular set of keywords and phrases).

In some embodiments, the process of extracting sentences and phrases at block 415 may include more sophisticated techniques than simple string comparisons. For example, techniques including but not limited to fuzzy matching, syntactic and semantic analysis, and the like, as will be known to those skilled in the art. It will be appreciated that such techniques may be used, configured and/or applied to the systems and methods described herein.

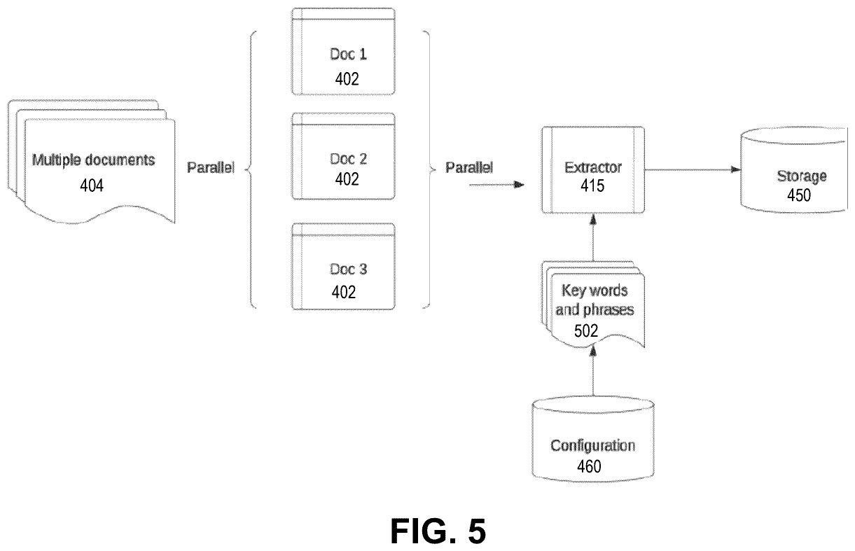

In some embodiments, after extraction from batch 404, process 400 proceeds to mapping sentences to each specific requirement and/or question from the set of requirements and/or questionnaires in the configuration 460 for each assessment to be run. FIG. 5 depicts an example process of sentence to requirement mapping block 420.

In this example, a requirement may have been expressed as a question (e.g., “is the vendor ISO 27001 certified?” or “is SOC1 available?”). Extraction block 410 may have extracted a plurality of sentences from documents 402 of batch 404 in which an entity defined as being ISO 27001 certified was found. At block 420, all such sentences may be mapped to requirements/questions that are configured with that entity. As depicted in FIG. 5, such processing may be performed in parallel so as to reduce processing time.

In some embodiments, multiple requirements and/or questions may be mapped to the same extracted sentence from a document 402. Likewise, multiple requirements and/or questions may be mapped to multiple sentences from a document 402. The output of said mappings may be stored and, in some embodiments, identified by the name of the set of requirements/questions as configured.

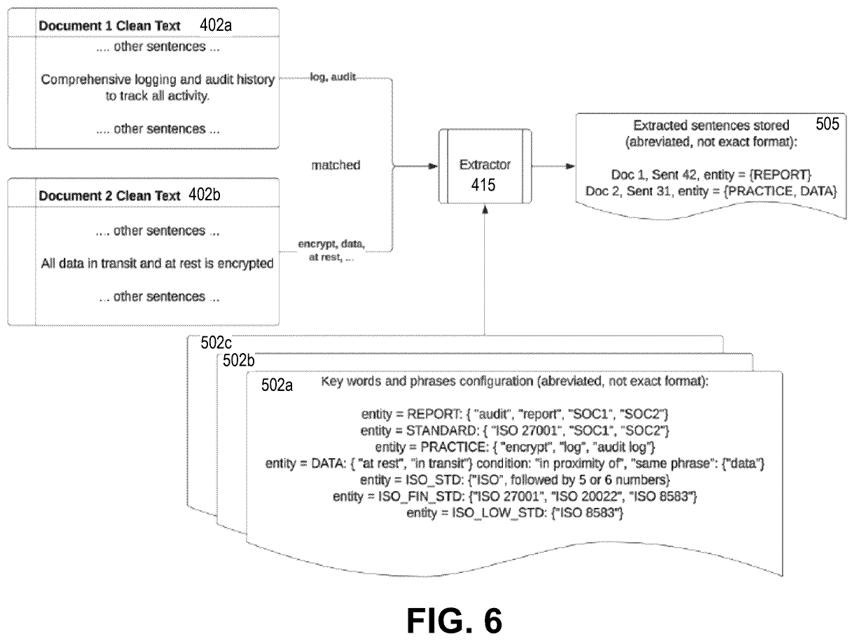

In some embodiments, each batch run may include multiple assessments, which each assessment having potentially multiple sets of requirements and/or questions within each set. As depicted in the example of FIG. 6, configuration 460 includes multiple sets of keywords and phrases 502a, 502b, 502c. In some embodiments, a particular assessment (e.g., a security assessment) may have one or more configured sets of requirements/questions which each represent a policy document. In some embodiments, policies may include one or more of Data in Transit, Data at Rest, Network, Physical Security Requirements, and the like.

For different vendors and product combinations, there may be different assessments required, and each assessment may require different combinations of sets of requirements (e.g., depending on the type of service, combination of features, type of integration, or the like). Some embodiments of the systems and methods disclosed herein may advantageously provide the ability to automatically extract relevant information from unstructured text (e.g., from documents 402) based on configuration 460, and evaluate and assess the information extracted therefrom.

Some embodiments may be particularly suitable for complex situations in governance and compliance processing, in which full machine/software data collection, integration and processing of structured data (e.g., through APIs) is not available or possible, and in scenarios in which a combination of full integration and manual document processing may be needed. For example, some vendors may provide REST API endpoints to provide technical data in real-time (such as up-time, number of sessions, or the like). Such raw evidence data may be collected continuously and may be automatically processed before such data is suitable for compliance and/or risk assessments. Contrastingly, some compliance requirements require an analysis of documents such as organizational structure charts which delineate lines of responsibility and separation of roles, describing processes and procedures, and reports (such as, for example, a System and Organizational Compliance 2 reports, also referred to as SOC2 reports). Such documents are unstructured, and data must be extracted from these documents and then merged with the automatically extracted data for specific compliance assessments. Some embodiments disclosed herein may enable better or full automation in such scenarios, by allowing domain experts to set up requirements for automatic extraction of data from such unstructured text documents.

FIG. 6 depicts an example process of sentence to requirement mapping block 420. As depicted in FIG. 6, one 502a of a plurality of sets of key words and phrases 502a, 502b, 502c contains a plurality of keywords and phrases relating to reporting, standards, practices, data, data security, and the like. The clean text version of example document 402a includes, among other sentences, the string “comprehensive logging and audit history to track all activity”. Relative to keyword and phrase set 502a, the word “audit” (based on “fuzzy matching” with “audit”) match and is extracted and stored in a mapping document 505. As depicted, mapping document 505 contains a record that sentence 42 of document 402a contains a mapping for the REPORT entity. For the purposes of simplicity, FIG. 6 depicts only a mapping for the REPORT entity. In other embodiments, mapping document 505 might also include a mapping for the PRACTICE entity (as the keyword and phrase set 502a for PRACTICE includes “log” and “audit log”, and as such the words “log” and “audit” might match based on “fuzzy matching”).

Similarly, the clean text version of example document 402 includes, among other sentences, the string “All data in transit and at rest is encrypted”. Relative to keyword and phase set 502a, the words “encrypt”, and “data” in the same phrase as “at rest” match and are extracted and stored in mapping document 505 (as documents 402a and 402b are part of the same batch 404), which records that sentence 31 of document 402b contains mappings for both the PRACTICE entity (“encrypt”) and the DATA entity (“at rest” in the same phrase as “data”). Mapping document 505 may be stored in storage 450 for use in subsequent blocks of process 400.

Returning to FIG. 4, the results of sentence to requirement mapping block 420 may then be used at requirement completeness evaluation block 425. In some embodiments, block 425 may perform an evaluation to determine whether sufficient data has been extracted from batch 404 for each requirement/question and for each set of requirements/questions for each assessment. For example, if insufficient data has been extracted to arrive at a successful assessment for a particular assessment, process 400 may be configured to economize on processing resources by not performing block 430.

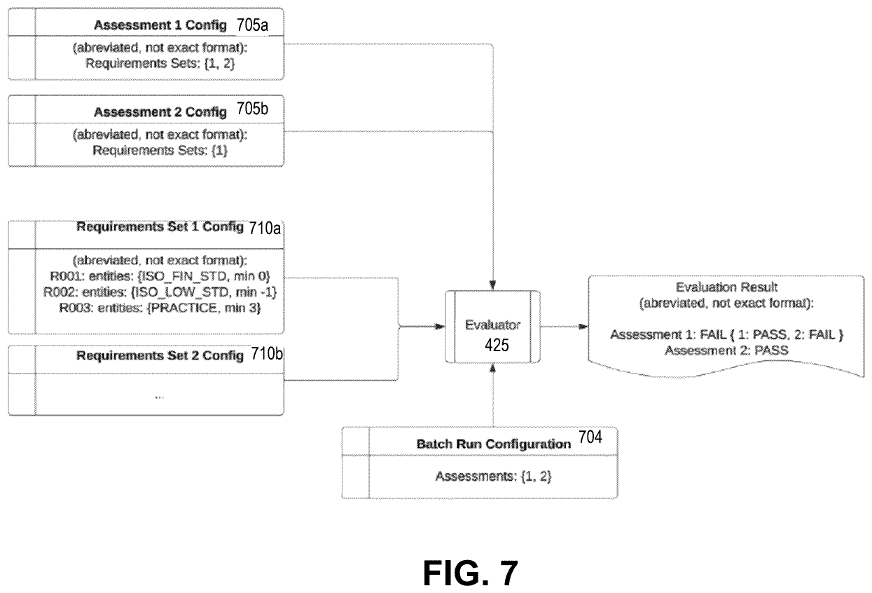

FIG. 7 provides a depiction of an example process of requirement completeness evaluation 425. In some embodiments, evaluation block 425 may be based on a requirements set configuration 710 which specifies the minimum mapping requirements for each requirement/question and for each set of requirements/questions for each assessment. It should be noted that in some embodiments, each requirement/question may have a separate set of mapping requirements associated therewith for a given assessment. In some embodiments, it may be not necessary for all mapping requirements to be present or satisfied to perform an assessment. However, in some embodiments, certain mapping requirements may be mandatory for an assessment to be run, whereas other mapping requirements might not be mandatory for an assessment to be run.

As an example, a requirement might be the presence of multiple audit reports. It is possible that multiple audit reports are found in block 420, that a single audit report is found in block 420, or that no audit reports are found in block 420. An example minimum requirement could be that in order to proceed to assessment block 430, at least one mapping for an audit report must be found in block 420. In this example, if no mapping is found for the audit report requirement, then process 400 will not proceed to assessment block 430. If at least one mapping for the audit report requirement is found in block 420, process 400 may continue to block 430.

In some embodiments, an assessment may have numerous sets of requirements/questions. Thus, evaluation 425 will be carried out for each requirement/question for a particular assessment prior to determining whether to proceed to assessment block 430 or not. In some embodiments, evaluation block 425 may determine that not enough data is available in document batch 404 to proceed with an actual assessment at block 430.

It should be appreciated that in some embodiments, because multiple assessments can be configured for one batch run, some assessments may be able to proceed for batch 404, while other assessments might not proceed. Advantageously, evaluation block 425 can execute evaluations for each requirement in parallel, and results collected for the set and the evaluation at each set level may also be executed in parallel, which offers significant reductions in the time required to make sure determinations.

As depicted in FIG. 7, evaluation block 425 may receive, as inputs, one or more assessment configurations 705a, 705b and one or more requirement sets 710a, 710b. In the example depicted in FIG. 7, requirements set configuration 1 710a defines 3 separate minimum mapping requirements for certain entities (e.g., ISO_FIN_STD being a minimum of 0, ISO_LOW_STD being a minimum of −1, and PRACTICE having a minimum number of mappings of 3). Although not depicted, it will be appreciated that requirements set configuration 2 710b defines additional requirements for various entities.

As depicted, assessment configuration 1 705a incorporates both of requirements sets 1 710a and 2 710b, and assessment configuration 2 705b incorporates only requirements set 1 710a. Batch run configuration 704 may be sent to evaluation block 425. As depicted, batch run configuration 704 contains instructions to perform assessments 1 and 2, which, as noted above, may have distinct requirements set configurations 710a, 710b associated therewith. In some embodiments, evaluation block 425 is configured to provide an evaluation result for each of assessment 1 705a and assessment 2 705b.

As depicted in this example, batch run 704 satisfies the minimum requirements specified by requirements set 1 710a, but does not satisfy the minimum requirements set 2 710b. As such, evaluation block 425 returns a pass for assessment 2 705b (which only requires compliance with requirements set 1 710a), and returns a fail for assessment 1 705a (which requires compliance with both requirements set 1 710a and requirements set 2 710b). Thus, in the example embodiment depicted in FIG. 7, assessment 2 705b would be sent to assessment block 430 for further processing, while assessment 1 705a would not be sent to assessment block 430. Thus, computing resources may be economized by only using computing resources to perform assessment 2 (since assessment 1 would be assured to fail a full assessment, as the mappings do not satisfy the minimum requirements as defined in requirements sets 1 and 2 710a, 710b).

In some embodiments, once evaluations have been completed for each set of requirements at block 425, process 400 may continue to assessment block 430. In some embodiments, at assessment block 430, rules are applied to calculate a score for each requirement/question. In some embodiments, each score may be given a weight. Thus, in some embodiments, a weighted score may be calculated for each set of requirements/questions. In some embodiments, the weighted score for each set of requirements/questions may be combined into assessment score for each assessment configured for each batch run. In some embodiments, assessment scores may be stored in storage 450. In some embodiments, users may be able to access results and apply different filters and/or aggregations to results, compare results with historical data, and various other analytics.

In some embodiments, assessment block 430 is only executed when there is sufficient data extracted to meet the minimum assessment requirements for a given assessment, as noted above. An instructive analogy illustrating the difference between evaluation and assessment blocks is the process of applying for an undergraduate degree at a university. The evaluation step may be analogized to the university making the determination as to whether the documents submitted by an applicant meet the minimum submission criteria (e.g., “has the applicant submitted proof they have graduated from high school, such as a high school transcript?”). If the documents do not meet the minimum criteria, the application will not be considered further, and time and effort may be saved by discarding the application without any further analysis. If the documents from the applicant meet the minimum criteria, then the university would proceed to an assessment step which can be analogized to the university taking a more in-depth analysis of the applicant's submitted documents in order to determine whether they qualify for admission to the undergraduate program (e.g., considering the applicant's grades in various courses). In this analogy, it will be appreciated that the fact an applicant has not submitted their transcript from high school does not necessarily mean that the applicant did not graduate from high school—it simply means that insufficient information has been provided to make that assessment, and therefore there is no point in spending resources on making that assessment.

In some embodiments, assessment block 430 functions by receiving a requirement assessment configuration 802, which includes a plurality of requirements 804a, 804b, 804c requirements for a particular assessment. In some embodiments, assessment block 430 analyzes each requirement 804a, collects extracted sentences 505 that are relevant to respective requirement 804a, and assesses the meaning of the relevant extracted sentences 505.

As an example, for an assessment such as a data security assessment, a requirement 804a could be that a vendor product must support Bring Your Own Key (BYOK) for encryption of data at rest. In some embodiments, evaluation block 425 would return a “pass” if an extracted sentence 505 matches the “encryption of data at rest” entity, thereby allowing the process to proceed to assessment block 430. If, however, no extracted sentences match the “encryption of data at rest” entity, the assessment would not proceed to block 430. In some embodiments, assessment block 430 determine whether BYOK is supported or not supported (e.g., based on the meaning of extracted sentences 505), and produce a score based on the configuration. It will be appreciated that in situations in which there is no extracted sentence 505 matching the “encryption of data at rest” entity, it would be inaccurate and unhelpful to conduct an assessment at block 430 and obtain the result that BYOK is not supported (as the lack of relevant information about BYOK is not an indication in either direction as to whether BYOK is supported or not supported).

In some embodiments, performing an assessment at block 430 may include numerous independent calculations. For example, an assessment for one individual requirement 804a may include an ensemble of one or more different algorithms 808a, 808b, 808c. In some embodiments, each algorithm may have a different configuration for the same requirement 804a (or set of requirements 804a, 804b, 804c). In some embodiments, each assessment of a single requirement 804a or set of requirements 804a, 804b, 804c may use a different algorithm to process the same set of extracted text or sentences 505. It will be appreciated that many different algorithms may be contemplated for the evaluation of a requirement.

For example, an example assessment algorithm might search for at least one of a set of exact strings of text within extracted sentences 505. Another example assessment algorithm might use fuzzy matching to find one or more strings or phrases within extracted text 505. Still another example algorithm might require that there be no matches for one or more specific keywords or phrases within extracted sentences 505 (e.g., “there should be no matches for “TLS 1.0” or “TLS 1.1”).

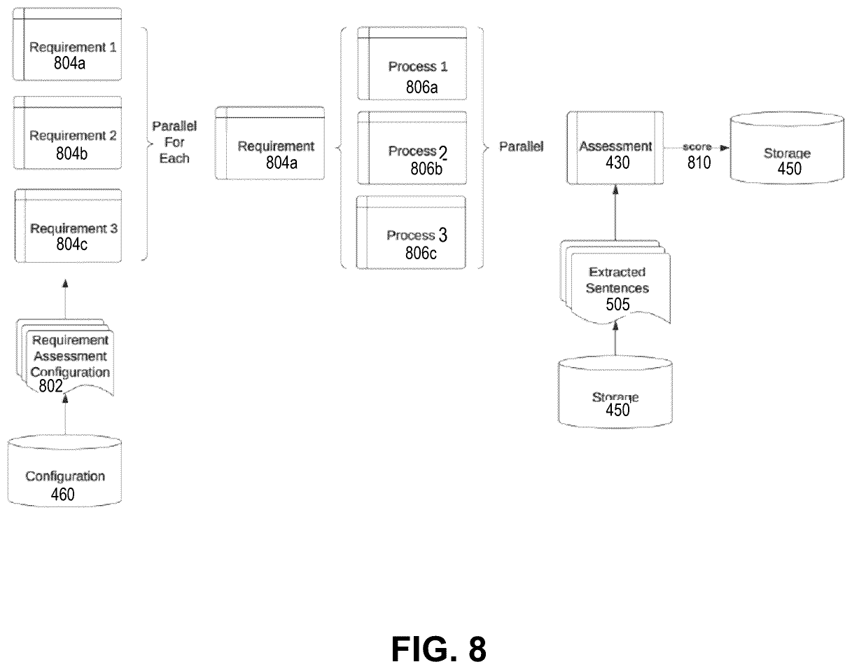

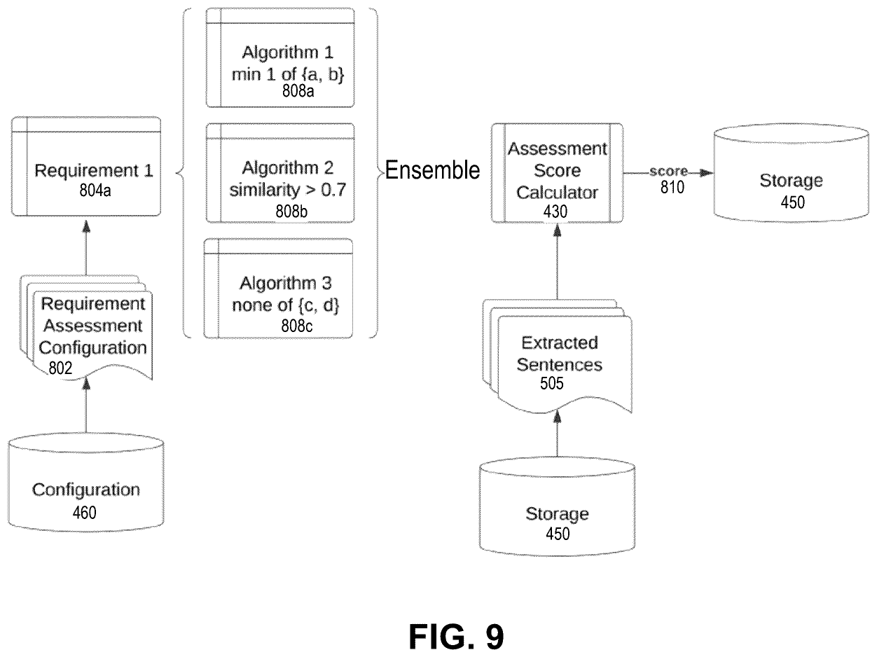

In some embodiments, different assessment algorithms 808 may be independent and therefore capable of being processed in parallel processes 806a, 806b, 806c, as depicted in FIGS. 8 and 9. Once parallel processing is complete, each algorithm may output a score 810 which may be saved to storage 450. In some embodiments, as depicted in FIG. 9, two or more scores may be combined using an algorithm (such as, for example, weighted or randomized majority algorithms) to obtain a single overall assessment score 810 for each requirement of each assessment. It should be noted that although FIG. 9 uses the terminology “ensemble”, this is not necessarily the same technique as ensemble machine learning techniques. For example, some embodiments may incorporate modified ensemble learning techniques to calculate a single score using simpler atomic requirement configurations which may be easier for domain experts to understand, create, and/or modify.

In some example embodiments, assessment block 430 may provide the following functionality. A requirement 804 may be configured or implemented as a count of entities beyond a threshold. For example, an example requirement might be “must support one item in the configuration list” (or a number other than one, in other embodiments). An example item in the configuration list might be “must support encryption of data at rest”. In this manner, domain knowledge experts may be able to deconstruct complex requirements into simpler, clearly articulate atomic assessment requirements which can be implemented. For example, for risk assessments, domain knowledge experts may be able to formulate atomic requirements based on what they are looking for. This aspect of some embodiments may allow for much simpler, less expensive models and tools to be used (which may achieve the same or better results and performance than using LLMs, without all of the drawbacks outlined above regarding LLMs).

In some embodiments, systems and processes described herein may be optimized for specific sets of use cases and problems, particularly where the data/information extraction and assessment steps are pre-determined. Moreover, systems and process described herein may perform especially effectively when processing a finite batch of documents (e.g., under 1000 documents) in a pre-determined, pre-configured run. Nevertheless, it will be appreciated that the configurations described herein are quite flexible in their implementation.

In some embodiments, configurations 802 for assessment may include requirements 804 which are atomic requirements. In some embodiments, atomic requirements may be generated based on, for example, rule sources such as organization-specific and/or other specific requirement source documents (e.g., regulatory documents, policy documents, technical standards documents, risk & compliance documents, and the like). In some embodiments, atomic requirements may be extracted from such rules sources using a compliance mapping system as described, for example in, U.S. Provisional Patent Application Nos. 63/591,549 and 63/591,590, filed Oct. 19, 2023, the contents of which are incorporated herein by reference in their entireties.

In some embodiments, a non-exhaustive list of example requirements 804 may include a) must support encryption of data at rest, b) must support BYOK for encryption of data at rest, c) must support encryption of data in transit, and d) must support daily backup of data at rest. For each atomic requirement, the assessment configuration may specify parameters for each process 806. As depicted in FIGS. 8 and 9, each process 806 may be executed in parallel for each requirement, with the results being aggregated into an overall score 810 for that requirement. Processes 806 may include a variety of data analysis techniques, including similarity comparisons between extracted sentences 505 and requirement text and/or similarity between all sentences combined, and the results may be mathematically combined in various ways to obtain an overall similarity score. Moreover, sets of previously extracted and labeled entities may be correlated as well. In some embodiments, such correlating may be the complete assessment for a requirement. In other embodiments, the assessment may include additional scores (e.g., finding additional keywords and phrases). In some embodiments, such additional scores may be based on relatively specific conditions including syntactic and semantic analysis (e.g., finding a specific noun(s) only if it appears after a particular adjective(s)).

In some embodiments, requirement assessment configuration 802 may specify weights to be given sub-scores (e.g., results of 808a, 808b, 808c). Such weights may determine the relative importance of each sub-process relative to the total requirement-specific score for a requirement. Moreover, each requirement within an assessment may be assigned a weight used to calculate the overall score for the assessment. Further, in some embodiments, requirements may be grouped within each assessment and scores may be calculated for sub-groups of requirements based on configured subgroup-specific weights.

It should be appreciated that assessment block 430 provides a set of scores for atomic requirements based on the configuration, an overall score for each requirement, and/or an overall score for the assessment. In some embodiments, interpretation and/or remediation based on these scores may be performed by other components of a broader system. For example, if the BYOK requirement for an assessment is not met, assessment block 430 would calculate the score in accordance with the configuration, irrespective of whether remediation is required or not. In some embodiments, process 400 may be configured to generate an explanation or audit of why a particular assessment failed. For example, if a requirement assessment configuration 802 specifies that a particular requirement (e.g., support for BYOK) has a weighting of 0.9 (that is, the overall score for the assessment is determined nearly completely by whether there is support for BYOK), then a low score might be indicative that BYOK is not supported (and thus provide administrators with information as to why a particular product or service is non-compliant).

In some embodiments, one or more of administrators and other groups of users may be permitted to define and change configuration settings (e.g., by entering commands through interface 462 via system administration API 461). In some embodiments, users may be further permitted to interactively specify ad-hoc parameters and re-run some parts of all of a batch 404. Users may be further permitted to select different sets of documents 402 and/or create new batches 404, new assessments 802, and the like.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method comprising:
receiving a plurality of documents;
defining a batch comprising a subset of said plurality of documents;
extracting, from each document of said batch, unstructured text;
extracting, from said extracted unstructured text, a plurality of text segments;
labelling and/or mapping one or more of said plurality of text segments to one or more requirements from a set of requirements configured for an assessment;
evaluating whether said labelled and/or mapped text segments satisfy a minimum requirement threshold associated with said set of requirements for said assessment; and
when said minimum requirement threshold is satisfied, determine assessment scores for each requirement in said set of requirements for said assessment.

2. The method of claim 1, wherein said assessment is one of a compliance assessment and a risk assessment.

3. The method of claim 1, wherein said plurality of documents comprise one or more product and/or vendor documents.

4. The method of claim 1, wherein said set of requirements is a first set of requirements, and wherein said labelling and/or mapping comprises labelling and/or mapping said one or more text segments to a second set of requirements configured for said assessment.

5. The method of claim 4, wherein said labelling and/or mapping of said first and second sets of requirements is performed in parallel.

6. The method of claim 1, wherein said labelling and/or mapping of said first set of requirements is performed in parallel for each of said requirements of said set of requirements.

7. The method of claim 1, further comprising labelling and/or mapping said plurality of text segments to a set of requirements configured for a second assessment distinct from said first assessment.

8. The method of claim 7, wherein said labelling and/or mapping of said text segments is performed in parallel for said first assessment and for said second assessment.

9. The method of claim 1, further comprising generating a unique identifier for said batch, wherein said unique identifier comprises at least one of a universally unique ID (UUID) and a composite key, said composite key comprising at least a batch checksum and a date and time of creation of said batch.

10. The method of claim 9, wherein each of said documents included in said batch includes a checksum value, and wherein said batch checksum is calculated based on said checksums of each document.

11. The method of claim 10, wherein said batch checksum is calculated by concatenating said checksum of each document and creating a checksum of the concatenated checksum string.

12. The method of claim 1, wherein said set of requirements corresponds to a policy document.

13. The method of claim 12, wherein said policy document is one of data in transit, data at rest, network, and physical security requirements.

14. The method of claim 1, wherein said determining assessment scores comprises applying a plurality of preconfigured rules to calculate a score for each requirement of said set of requirements.

15. The method of claim 14, wherein each of said requirements comprises a weighting, and said method further comprises determining an overall score for said assessment based on a weighted combination of said scores for each of said requirements.

16. The method of claim 14, wherein for at least one requirement of said set of requirements, a plurality of distinct algorithms are applied to determine a plurality of scores for said respective requirement, and said score for said requirement is based on an ensemble of said plurality of scores determined based on said plurality of distinct algorithms.

17. A system comprising:
a processor; and
a computer-readable storage medium having stored thereon computer-executable instructions that, when executed by said processor, cause the processor to perform a method comprising:
receiving a plurality of documents;
defining a batch comprising a subset of said plurality of documents;
extracting, from each document of said batch, unstructured text;
extracting, from said extracted unstructured text, a plurality of text segments;
labelling and/or mapping one or more of said plurality of text segments to one or more requirements from a set of requirements configured for an assessment;
evaluating whether said labelled and/or mapped text segments satisfy a minimum requirement threshold associated with said set of requirements for said assessment; and
when said minimum requirement threshold is satisfied, determine assessment scores for each requirement in said set of requirements for said assessment.

18. A computer-readable storage medium having stored thereon computer-executable instructions that, when executed by said processor, cause the processor to perform a method comprising:
receiving a plurality of documents;
defining a batch comprising a subset of said plurality of documents;
extracting, from each document of said batch, unstructured text;
extracting, from said extracted unstructured text, a plurality of text segments;
labelling and/or mapping one or more of said plurality of text segments to one or more requirements from a set of requirements configured for an assessment;
evaluating whether said labelled and/or mapped text segments satisfy a minimum requirement threshold associated with said set of requirements for said assessment; and
when said minimum requirement threshold is satisfied, determine assessment scores for each requirement in said set of requirements for said assessment.
